(19) United States
(12) Patent Application Publication
(10) Pub. No.: US 2007/0116547 A1
(43) Pub. Date: May 24, 2007

(54) Protective tip for the tines of a forklift truck

(75) Inventor: Guy Vicary Owen Bulkeley, Pretoria (ZA)

Correspondence Address: DENNIS G. LAPOINTE;LAPOINTE LAW GROUP, PL, PO BOX 1294, TARPON SPRINGS, FL, 34688-1294, US

(73) Assignee: Big D Bumpers CC, Pretoria (ZA)

(21) Appl. No.: 11/282,790

(22) Filed: Nov. 18, 2005

(51) Int. Cl. B66F 9/18

(52) U.S. Cl. 414/607

(57) ABSTRACT

A protective tip for a tine of a forklift truck where in a preferred embodiment, the tip comprises a body that defines a recess for accommodating the end of the tine. The body is substantially U-shaped and comprises a bight portion defining a substantially planar front face and a rear, curved contact face, and a pair of arms that snugly receive the end of the tine. Significantly, the ends of the arms project upwardly so as to define a clearance between the bottom of the tine and the bottom of the tip. This height difference ensures that it is the protective tip that wears down, and not the tine itself. The tip is secured to the tine by at least one pair of grub screws, which extend through apertures defined in the arms of the tip.

### BACKGROUND OF THE INVENTION

This invention relates to a protective tip for the tines of a forklift truck.

The primary purpose of forklift trucks is to lift and move pallets stacked with a load of materials and/or goods. Typically, this requires the tines to scrape against the floor as the tines engage the pallet and/or goods. The resulting wear on the bottom face of the tines has two significant consequences. Firstly, the wearing down of the heel of the tines requires that the tines be replaced at regular intervals, which is an expensive and time-consuming exercise. Secondly, the wearing down of the tines causes the edges, and in particular the front ends, of the tines to become razor-sharp, as well as to reduce the overall length of the tines themselves. Not only is this extremely dangerous and hazardous, but it can also cause tremendous damage to the structure and integrity of the pallets and/or goods. In addition, the risk of damage to equipment, machinery, people and products within the vicinity of the truck is also significantly increased.

It would therefore be desirable to provide a solution to the problems mentioned above.

### SUMMARY OF THE INVENTION

According to the invention there is provided a tip for a tine of a forklift truck, the tine comprising bottom and top faces and end and side edges, the tip comprising:

a body that defines a front contact face terminating in a bottom edge; and securing means for securing the body to the end of the tine so as to define a clearance between the bottom face of the tine and the bottom edge of the front contact face.

Preferably, a contact shoe extends from the bottom edge of the body so as to accommodate the end of the tine, with the contact shoe also being arranged to define a clearance between the bottom face of the tine and the bottom edge of the front contact face.

Conveniently, the width of the shoe and/or the body is at least the same as the width of the tine.

Advantageously, the contact shoe is either integrally formed with the body or removably fittable to the body.

Typically, the securing means includes a pair of arms that extend from the contact shoe. Alternatively, or in addition, the securing means includes a pair of arms that extend from the front contact face of the body.

Preferably, the securing means comprises mechanical fastening means and/or an adhesive.

Conveniently, the front contact face of the body carries a resilient, shock absorbing material.

In one version of the invention, the resilient, shock absorbing material is fitted to an intermediate connecting clip, with this clip being arranged to be releasably fitted to the front contact face of the body.

In yet a further version of the invention, a plurality of rollers is rotatably fitted to a shaft mounted to the front contact face of the body.

Typically, the front contact face is substantially planar.

### BRIEF DESCRIPTION OF THE DRAWINGS

FIG. 1 shows a perspective view of a protective tip for a tine of a forklift truck according to a first embodiment of the present invention;

FIG. 2 shows a side view of the tip shown in FIG. 1;

FIG. 3 shows a top view of the tip shown in FIG. 1;

FIG. 4 shows a perspective view of a protective tip for a tine of a forklift truck according to a second embodiment of the present invention;

FIG. 5 shows a top view of a protective tip for a tine of a forklift truck according to a third embodiment of the present invention;

FIG. 6 shows a perspective view of a protective tip for a tine of a forklift truck according to a fourth embodiment of the present invention;

FIG. 7 shows a side view of the tip shown in FIG. 6; and

FIG. 8 shows a top view of the tip shown in FIG. 6.

### DESCRIPTION OF PREFERRED EMBODIMENTS

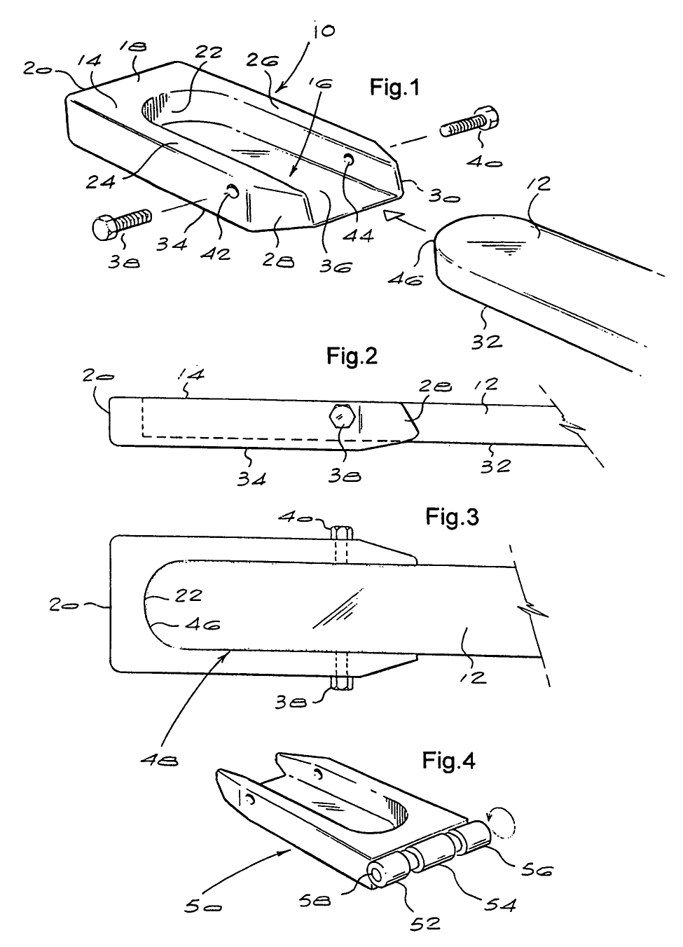

Referring first to FIGS. 1 to 3, a protective tip 10 for a tine 12 of a forklift truck according to a first embodiment of the present invention comprises a body 14 that defines a recess 16 for accommodating the end of the tine 12. The body 14 is substantially U-shaped and comprises a bight portion 18 defining a substantially planar front face 20 and a rear, curved contact face 22, and a pair of arms 24 and 26 that snugly receive the end of the tine 12.

Alternatively, the end of the tine can be cut straight so that the front edge of the tine is substantially perpendicular to the length of the tine, with the rear contact face of the body accordingly also extending perpendicularly to the arms of the body. Thus, with this arrangement, the front face of the tine will sit flush against the rear contact face of the body.

Significantly, the ends 28 and 30 of the arms 24 and 26, respectively, project upwardly so as to define a clearance between the bottom 32 of the tine 12 and the bottom 34 of the tip 10. This height difference ensures that it is the protective tip 10 that wears down, and not the tine 12 itself.

Another important feature of the present invention, shown particularly well in FIGS. 2 and 3, is the substantially planar, or flat, front face 20. This feature ensures that, in the event of the tine 12 fitted with the tip 10 striking an object, the resulting damage will be minimal.

To reduce wear on the tip 10, a contact plate or shoe 36 can be fitted to the bottom of the tip 10. The shoe 36 follows the bottom profile of the tip 10 by also extending upwardly at the ends 28 and 30 of the arms 24 and 26. The shoe 36 may be either integrally formed with the body 14 or it may be removably fitted to the body 14.

The tip 10 and shoe 36 are typically manufactured from mild steel, which provides an extremely hard and abrasive-resistant structure. Alternatively, the tip 10 and shoe 36 can be manufactured from a polyurethane plastics material.

The tip 10 is secured to the tine 12 by means of at least one pair of grub screws, such as screws 38 and 40, which extend through apertures 42 and 44 defined in the arms 24 and 26 of the tip 10. In addition, the front edge 46 of the tine can optionally be tacked to the rear contact face 22 of the bight portion 18 by means of a fillet weld, which is indicated generally by reference numeral 48.

Alternatively, it is envisaged that the tip 10 can simply be bonded to the tine 12.

Turning now to FIG. 4, an alternative tip 50 of the present invention is similar in structure to the tip 10 described above, save that it has a plurality of horizontally extending rollers 52, 54 and 56 that are rotatably fitted to a shaft 58 mounted to the front face of the tip 50. The purpose of these rollers 52, 54 and 56 is to urge the tip 50, and thus the tine 12, upwardly or downwardly in the event of the tip 50 striking a substantially flat face of the pallet and/or goods due to misalignment.

Alternatively and/or in addition, the tip 50 can be fitted with a plurality of vertically extending rollers to urge the tip 50, and thus the tine 12, sidewardly in the event of the tip 50 striking a side edge of the pallet and/or goods

Preferably, the rollers are manufactured from rubber, which advantageously absorbs shock. Clearly, the rollers can be constructed from any other suitable material, such as stainless steel. In addition, this aspect of the present invention is not limited to rollers as described and shown, with any rolling-type arrangement, such as a ball and socket arrangement, also being capable of being used by the invention to achieve the same objective.

Although the tip is shown as a body having bottom, front and side portions, it can also take the form of a sock or glove that totally encloses the front end of the tine. In this version, the two primary distinguishing features of the invention are also present, namely a substantially planar front face for reducing damage to pallets and products on the pallets, as well as means for spacing the bottom of the tine, in use, from the floor, thereby reducing wear on the tine 12 itself.

In addition, the contact face 18 need not be curved as shown in the figures, but may define a straight face that is parallel to the front face 20, for accommodating a corresponding straight front edge 46 of the tine 12.

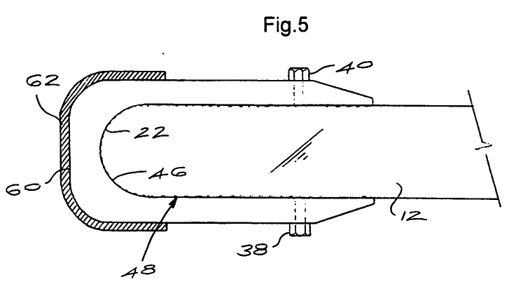

Turning now to FIG. 5, a preferred version of the protective tip of the invention has a curved front edge 60, which, advantageously, allows sideways movement. In addition, a strip of resilient, shock absorbing material, typically in the form of a rubber pad 62, can be bonded to the curved front edge 60, thereby further reducing damage to pallets and products on the pallets in the event of an accidental collision. Alternatively, although not shown, the rubber pad 62 can be fitted to an intermediate connecting clip, with this clip being arranged to be releasably fitted to the curved front edge 60. Advantageously, the rubber pad 62 can be bonded to the front edge 60 by a coloured bonding agent, so that when the colour of the bonding agent becomes visible, an indication is provided that the rubber pad 62 needs replacing.

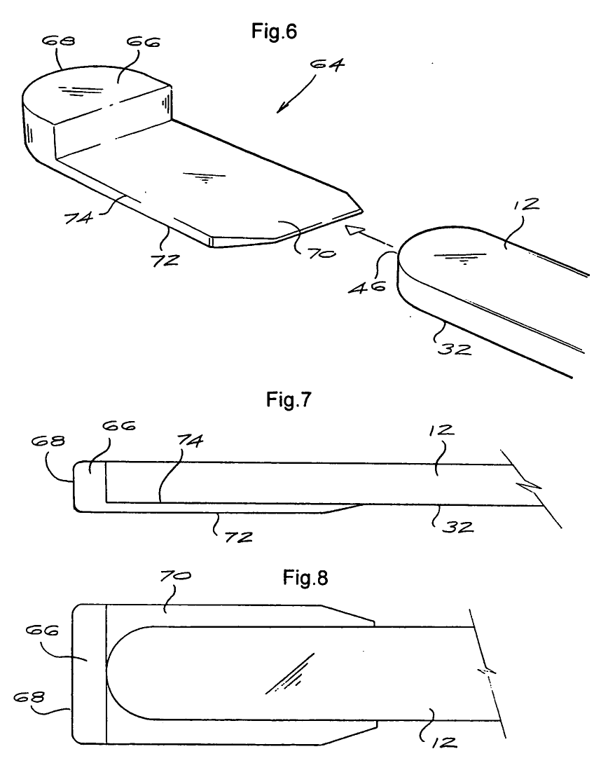

FIGS. 6 to 8 show a further protective tip 64 for a tine 12 of a forklift truck. The tip 64 includes an upstanding front portion 66 defining a front contact face 68. As mentioned above, this feature ensures that, in the event of the tine 12 fitted with the tip 64 striking an object, the resulting damage will be minimal.

The tip 64 further includes a contact plate or shoe 70 that is connected to the bottom of the front portion 66. The shoe 70 extends a certain distance along the length of the tine 12, once fitted, and is arranged to define a clearance between the bottom 32 of the tine 12 and the bottom 72 of the shoe 70 of the tip 64. Again, this clearance ensures that it is the protective tip 64 that wears down, and not the tine 12 itself.

Advantageously, in this version, the top 74 of the shoe 70 will be bonded to the tine 12. In addition, although not shown in FIGS. 6 to 8, the widths of the shoe 70 and the tine 12 will generally be similar.

Significantly, this tip 64 possesses the two primary distinguishing features of the invention, namely a front contact face for reducing damage to pallets and products on the pallets, as well as for spacing the bottom of the tine, in use, from the floor, thereby reducing wear on the tine 12 itself.

The present invention has a number of advantages. First, it is the protective tip that wears down, and not the tine itself, which greatly reduces the regularity with which the tines need to be replaced as well as damage caused by sharpened edges. Second, the tips themselves can be easily replaced, and can furthermore be conveniently retrofitted to existing tines.

Finally, although the protective tip is shown mounted to the front tip of the tine, it can also be fitted to the rear end of the tine, also known as the elbow of the tine, so as to further protect the tine.

I claim:

1. A tip for a tine of a forklift truck, the tine comprising bottom and top faces and end and side edges, the tip comprising:
a body that defines a front contact face terminating in a bottom edge; and
securing means for securing the body to the end of the tine so as to define a clearance between the bottom face of the tine and the bottom edge of the front contact face.

2. A tip for a tine of a forklift truck according to claim 1, wherein a contact shoe extends from the bottom edge of the body so as to accommodate the end of the tine, with the contact shoe also being arranged to define a clearance between the bottom face of the tine and the bottom edge of the front contact face.

3. A tip for a tine of a forklift truck according to claim 2, wherein the width of the shoe and/or the body is at least the same as the width of the tine.

4. A tip for a tine of a forklift truck according to claim 2, wherein the contact shoe is either integrally formed with the body or removably fittable to the body.

5. A tip for a tine of a forklift truck according to claim 3, wherein the contact shoe is either integrally formed with the body or removably fittable to the body.

6. A tip for a tine of a forklift truck according to claim 2, wherein the securing means includes a pair of arms that extend from the contact shoe.

7. A tip for a tine of a forklift truck according to claim 3, wherein the securing means includes a pair of arms that extend from the contact shoe.

8. A tip for a tine of a forklift truck according to claim 4, wherein the securing means includes a pair of arms that extend from the contact shoe.

9. A tip for a tine of a forklift truck according to claim 5, wherein the securing means includes a pair of arms that extend from the contact shoe.

10. A tip for a tine of a forklift truck according to claim 1, wherein the securing means includes a pair of arms that extend from the front contact face of the body.

11. A tip for a tine of a forklift truck according to claim 1, wherein the securing means comprises mechanical fastening means and/or an adhesive.

12. A tip for a tine of a forklift truck according to claim 1, wherein the front contact face of the body carries a resilient, shock absorbing material.

13. A tip for a tine of a forklift truck according to claim 12, wherein the resilient, shock absorbing material is fitted to an intermediate connecting clip, with this clip being arranged to be releasably fitted to the front contact face of the body.

14. A tip for a tine of a forklift truck according to claim 1, wherein a plurality of rollers is rotatably fitted to a shaft mounted to the front contact face of the body.

15. A tip for a tine of a forklift truck according to claim 1, wherein the front contact face is substantially planar.
